(19) United States
(12) Patent Application Publication
(10) Pub. No.: US 2007/0217335 A1
(43) Pub. Date: Sep. 20, 2007

(54) Method and apparatus to facilitate communication resource usage control

(75) Inventors: Shankar Jayaraman, Palatine, IL (US); Michael Borella, Naperville, IL (US); John Fijolek, Naperville, IL (US)

Correspondence Address: FITCH EVEN TABIN AND FLANNERY, 120 SOUTH LA SALLE STREET, SUITE 1600, CHICAGO, IL, 60603-3406, US

(73) Assignee: UTStarcom, Inc., Alameda, CA (US)

(21) Appl. No.: 11/377,067

(22) Filed: Mar. 16, 2006

(51) Int. Cl. H04J 1/16; H04L 12/56

(52) U.S. Cl. 370/235; 370/395.4; 370/252

(57) ABSTRACT

A network element can monitor (105) communication resource usage by, for example, a first end user. A determination (106) can then be had as to whether this first end user's communication resource usage exceeds a predetermined individual level of usage for that first end user (as distinguished, for example, from an upper limit as might be generically applied across an entire user population). When the first end user's communication resource does exceed this predetermined individual level of usage, automatic limitations regarding the first end user's communication resource usage can be imposed (108) while nevertheless continuing to facilitate the end user's communication resource usage.

### TECHNICAL FIELD

This invention relates generally to communications and more particularly to the apportionment of limited communications resources.

### BACKGROUND

Communications systems of various kinds are known in the art. Many such systems serve, at least in part, to provide a circuit-switched and/or data packet communication path for a plurality of end users. Cellular telephony networks represent one relatively ubiquitous example of such communications systems.

Facilitating a modern communication path typically entails allocating one or more of a variety of communication resources. Examples of such communication resources will vary from system to system but might include a bearer frequency or physical transport medium, a time slot, a spreading code, an encryption key, a percentage or rate of data throughput capability, and so forth.

Rapidly evolving end user platforms and corresponding services have led to problems with respect to ensuring a relatively equitable (or at least controlled) allocation of such communication resources. It is possible in many systems, for example, for a single end user to make use of a disproportionately large number of communication resources. This, in turn, can lead to a denial or reduction of services for a considerable number of other end users. Undue usage, for example, of peer-to-peer services by a few end users can readily create such problems in many wireless communication systems.

### BRIEF DESCRIPTION OF THE DRAWINGS

The above needs are at least partially met through provision of the method and apparatus to facilitate communication resource usage control described in the following detailed description, particularly when studied in conjunction with the drawings, wherein:

FIG. 1 comprises a flow diagram as configured in accordance with various embodiments of the invention;

FIG. 2 comprises a temporal schematic representation as configured in accordance with various embodiments of the invention;

FIG. 3 comprises a block diagram as configured in accordance with various embodiments of the invention;

FIG. 4 comprises a flow diagram as configured in accordance with various embodiments of the invention; and

FIG. 5 comprises a signal flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments a network element can monitor communication resource usage by, for example, a first end user. A determination can then be had as to whether this first end user's communication resource usage exceeds a predetermined individual level of usage for that first end user (as distinguished, for example, from an upper limit as might be generically applied across an entire user population although it is certainly possible and even probable in at least some application settings that many end users will have identical limits applied to their activities). When the first end user's communication resource does exceed this predetermined individual level of usage, automatic limitations regarding the first end user's communication resource usage can be imposed while nevertheless continuing to facilitate the end user's communication resource usage.

Such a determination can be made for an aggregate quantity of communication resource usage or can, if desired, be determined independently, for example, for both inbound and outbound communication paths and activities. Such teachings can further accommodate, if desired, temporal conditioning as well. As one example, the above-described determination of communication resource usage can be effected after a predetermined period of time following a predetermined event (such as, but not limited to, establishment of a call with the first end user).

So configured, the allocation of communication resources can be controlled with a high degree of granularity; in fact, at the level of the individual user, application, or the like. These teachings also permit considerable flexibility with respect to when and how such control is exerted. These benefits can be attained with relative ease, in a cost effective manner, and in the absence, for example, of re-programming an already-deployed base of end user platforms.

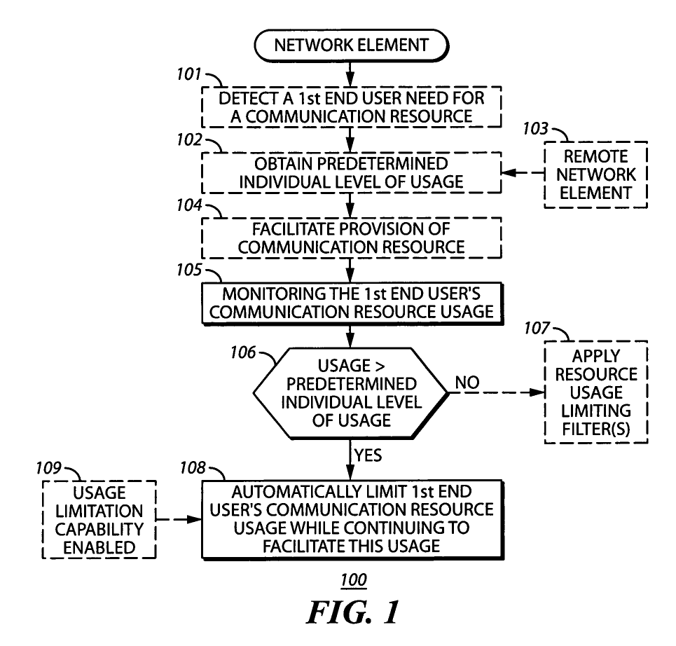

These and other benefits may become clearer upon making a thorough review and study of the following detailed description. Referring now to the drawings, and in particular to FIG. 1, a network entity of choice can implement a process 100 that provides for monitoring 105 communication resource usage by individual end users such as a first end user. This can comprise, for example, monitoring a quantity of transported data as corresponds to the monitored user(s). Such transported data can comprise, for example, data transmitted by the end user and/or data transmitted to the end user.

This process 100 then provides for determining 106 whether this monitored communication resource usage exceeds a predetermined individual level of usage for the monitored end user. By one approach, this can comprise determining whether a simple total aggregate quantity of data as corresponds to, for example, a given call session exceeds a predetermined threshold. By another approach this comparison can relate to a quantity of data as has been transported with respect to a particular amount of time. To illustrate, this can comprise a determination as to whether a predetermined individual level of usage has occurred during or after a predetermined period of time has passed following some predetermined event. An illustrative predetermined event might comprise, for example, the establishment of a call with the monitored end user.

Such temporal conditioning can be applied on a threshold-by-threshold basis if desired. For example, a more generous individual level of usage might be applied for inbound data being transmitted by an end user by granting that end user a greater duration of time before communication resource usage will be compared against the relevant predetermined individual level of usage threshold value and/or such comparison results used to control communication resource usage by the end user. To contrast, a less generous level of usage might then also apply to outbound data being transmitted to an end user by using a considerably shorter period of time before such comparisons are made or become effective.

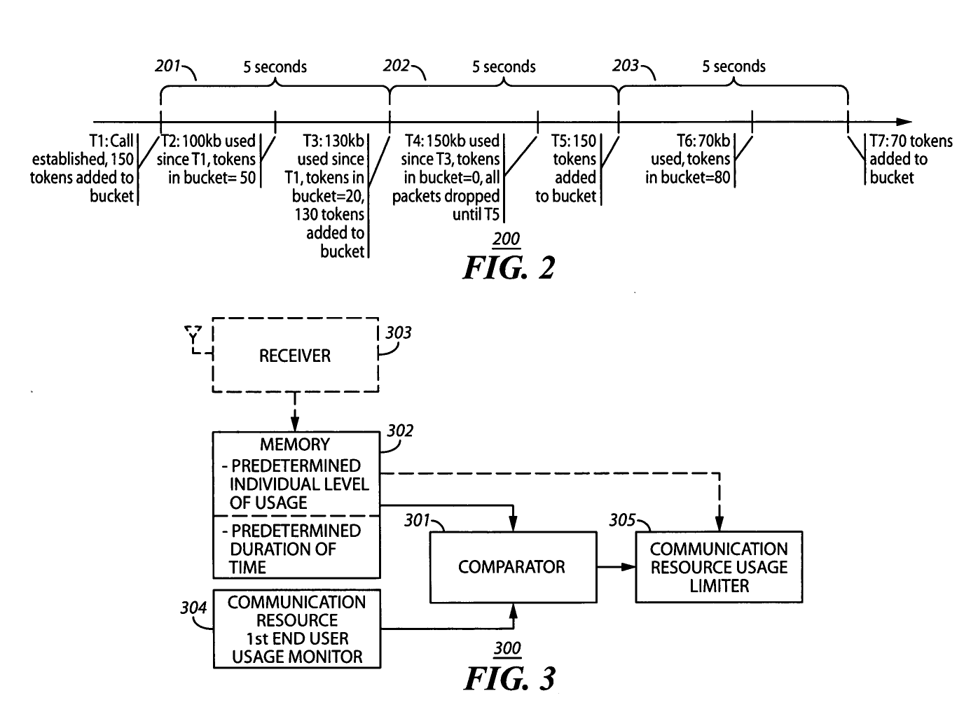

If desired, this determination step 106 can comprise use of a token bucket mechanism. Token bucket mechanisms are known in the art. Referring momentarily to FIG. 2, a brief description will be provided regarding how this mechanism could be employed in conjunction with these teachings. In this illustrative embodiment, the token bucket implementation 200 employs a five second token bucket refresh rate with three consecutive corresponding five second windows 201, 202, and 203 being shown. For purposes of this example, each token equates to 1 kilobit of data (which may comprise inbound data and/or outbound data as discussed above) and the predetermined individual level of usage is 30 Kilobits per second (which translates, of course, to a bucket depth of 150 tokens per each five second window.

At time T1 a call is established and the bucket is filled with 150 tokens. At time T2 this call has used 100 Kilobits and a bucket refresh has not yet occurred (as this first five second window 201 has not yet expired). By time T3, an additional 30 Kilobits has been used during the call. This leaves the bucket with 20 remaining tokens. Time T3 also represents the conclusion of the first five second window 201 and the beginning of the following five second window 202. Therefore, the bucket is replenished with a sufficient number of tokens to return the available number to 150 tokens.

In this example, at time T4 the call has depleted the bucket of all 150 tokens. This occurs when the end user is party to a transfer of 150 Kilobits of data since time T3 (corresponding to whichever link (or links) is being monitored). At this time, the above described decision step 106 would determine that the end user has now exceeded their predetermined individual level of usage.

At time T5, a next succeeding five second window 203 begins and the token depth is again replenished with 150 tokens. The above described process 100 would therefore now decide 106 that the end user is now again operating within the limits proscribed by the predetermined individual level of usage. To complete this brief illustrative example, by time T6 the end user has consumed only 70 tokens so far with no further tokens being consumed by the time this five second window 203 concludes at time T7 (at which time T7 the token bucket is again replenished to hold 150 tokens).

Returning again to FIG. 1, in cases where this determination 106 reveals that the monitored end user is not exceeding their individual level of usage, this process 100 can simply continue in any desired fashion. This can comprise, for example, simply looping back and continuing to monitor the end user's usage. If desired, however, by one optional approach this process 100 can additionally provide for applying 107 at least one resource usage limiting filter in such a case. This might comprise, for example, limiting resource usage by filtering with respect to at least one accessible network address limitation. This approach could be used, for example, to prohibit the end user from accessing a communication destination of choice by the system administrator or other responsible party.

When this determination 106 does reveal that the monitored end user is exceeding their permitted level of usage, this process 100 can then automatically limit 108 the end user's communication resource usage while nevertheless continuing to facilitate the end user's communication resource usage (by, for example, not dropping the call). This can be done, for example, by dropping one or more data packets as are presented subsequent to the permitted level of usage having been exceeded. To return again momentarily to FIG. 2, when employing a token bucket approach, this can comprise dropping all data packets as may be presented at any time when there are no tokens in the token bucket. To illustrate, at time T4, when all of the tokens in the token bucket have been consumed, this process 100 can provide for dropping all subsequent packets until time T5 when a fresh allotment of 150 tokens are provided to the token bucket.

If desired, such resource usage control can be rendered subject to other parameters, inputs, or circumstances of interest. As one example, this step of automatically limiting 108 an end user's communication resource usage when a predetermined individual level of usage has been exceeded can be made subject to a further consideration regarding what information resource the end user might be presently accessing. To illustrate, this process 100 can accommodate automatically limiting the end user's communication resource usage while continuing to facilitate that end user's communication resource usage when the communication resource usage comprises accessing a first information resource (such as a first Internet resource) and automatically not limiting this end user's communication resource usage when that communication resource usage comprises accessing a second information resource that is different than the first information resource (where, for example, the second information resource comprises a different Internet resource) notwithstanding that, in both cases, the end user may be operating in excess of the predetermined individual level of usage. Such an approach might be useful, for example, to permit an employee to have relatively generous access to business-related information resources while ensuring metered and controlled usage of non-business-related information resources.

This process 100 may accommodate additional steps and actions if desired. For example, this process 100 can optionally provide for detecting 101 the existence of a need by an end user for a communication resource. This might comprise, for example, simply detecting that the end user is signaling to request allocation of a communication resource in order to establish a call session.

This process 100 can also optionally provide for obtaining 102 the aforementioned predetermined level of usage for the end user (in response, for example, to detecting 101 the communication resource needs of the end user). This can vary with the needs and/or capabilities of a given application setting. By one approach the network element is simply pre-provisioned with this information. By another approach the network element receives this information regarding the predetermined individual level of usage from a remote network element 103. Various remote network elements 103 can serve in this regard. One illustrative example comprises an Authentication, Authorization, and Accounting (AAA) network element as is known in the art.

This process 100 can then optionally also provide for facilitating the provision of the needed communication resource to or on behalf of the end user. Actions such as this are well understood in the art and require no further elaboration here.

It may also be useful in some application settings to render some or all of these actions enabled or disabled 109 as a function of, for example, user and/or automated input. So configured, for example, a network administrator could be provided with the ability and option of selectively enabling or disabling 109 the step of automatically limiting an end user's communication resource usage when the end user's level of usage exceeds the predetermined value.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 3, an illustrative approach to such a platform will now be provided.

In this illustrative embodiment, a network element 300 (such as, but not limited to, a packet data serving node (PDSN)) can comprise a comparator 301 that operably couples to a memory 302 to receive the predetermined individual level of usage as pertains to a given end user and as is stored therein. As noted above, such information may, if desired, be provided via a remote network element. To facilitate such an approach, this network element 300 can further comprise an optional receiver 303 that provides for reception of the predetermined individual level of usage information from the remote network element. As noted above, these teachings may also employ predetermined durations of time. Accordingly, if desired, this memory 302 can also serve to store one or more predetermined durations of time (comprising, for example, corresponding temporal thresholds and the like).

The comparator 301 also operably couples to a communication resource first end user usage monitor. In a typical deployment, of course, this monitor will serve to observe the communication usage activities of a plurality of end users. This monitor can be configured and arranged, for example, as a monitor of quantities of transported data. As described above, this can comprise the monitoring of data being transmitted by the first end user and/or of data being transmitted to the first end user.

So configured, the comparator 301 provides a comparison result that corresponds to a comparison between the first end user's communication resource usage and the predetermined level of usage as individually corresponds to that particular end user. A communication resource usage limiter 305 operably couples to the comparator 301 and receives that comparison result. In this illustrative embodiment this communication resource usage limiter 305 is configured and arranged to operate in conformance with the teachings set forth herein. Accordingly, this communication resource usage limiter 305 serves to automatically limit the first end user's communication resource usage while also continuing to facilitate the end user's communication resource usage when the first end user's communication resource usage exceeds the predetermined individual level of usage.

By one approach, this communication resource usage limiter 305 comprises a data packet dropper (such as, but not limited to, a token bucket-based data packet dropper). This can comprise, if desired, use of one or more predetermined durations of time as may be stored in the memory 302. For example, this communication resource usage limiter 305 can be configured and arranged to determine whether the first end user's communication resource usage exceeds the predetermined individual level of usage beyond a predetermined period of time (following, for example, some predetermined event such as the establishment of a call). By such an approach, relatively short-lived data transmission/reception events that otherwise exceed the predetermined individual level of usage for a given end user can be tolerated without causing a corresponding limitation of that end user's communication resource usage.

Those skilled in the art will recognize and understand that such an apparatus 300 may be comprised of a plurality of physically distinct elements as is suggested by the illustration shown in FIG. 3. It is also possible, however, to view this illustration as comprising a logical view, in which case one or more of these elements can be enabled and realized via a shared platform. It will also be understood that such a shared platform may comprise a wholly or at least partially programmable platform as are known in the art.

As noted above, if desired, the predetermined individual levels of usage can be provided from a remote network element. For example, an authentication, authorization, and accounting (AAA) network element as is known in the art can be employed for such purposes and the level of usage information conveyed using, for example, remote authentication dial-in user service (RADIUS) messages.

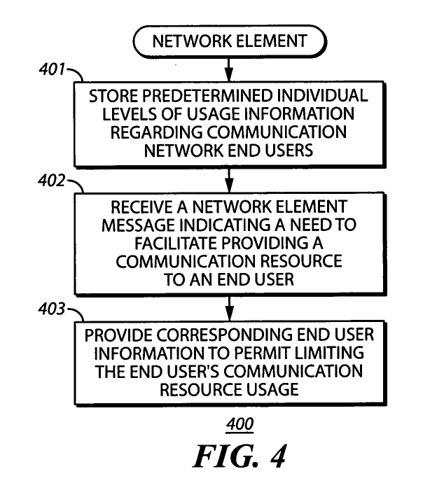

With reference now to FIG. 4, such a network element can be configured to implement a process 400 whereby the network element stores 401 information regarding a plurality of communication network end users, wherein the information comprises, at least in part, predetermined individual levels of usage information as is otherwise described herein. For example, this usage information can comprise a data quantity limit along with a data quantity trigger and/or a time based trigger to specify when corresponding actions based upon the data quantity limit may or should be taken or restricted. For example, the data quantity trigger can comprise a quantity of data that is sufficient to cause triggering of the use of the data quantity limit and the time-based trigger can comprise a quantity of time to be allowed to pass before triggering usage of the data quantity limit. This data quantity limit itself can comprise, for example, an individual limit for each of a forward data transport direction and a reverse data transport direction (and, if desired, each such individual limit can have separate discrete quantity and/or time based triggers associated therewith as well).

This process 400 then provides for receiving 402 a message from another network element (such as, but not limited to, a packet data serving node) indicating a need to facilitate providing a given communication network end user with a communication resource (or resources). This process 400 can then responsively provide 403 the information as corresponds to the given communication network end user to the opposing network element such that the latter can use the information to limit communication resource usage by the given communication network end user.

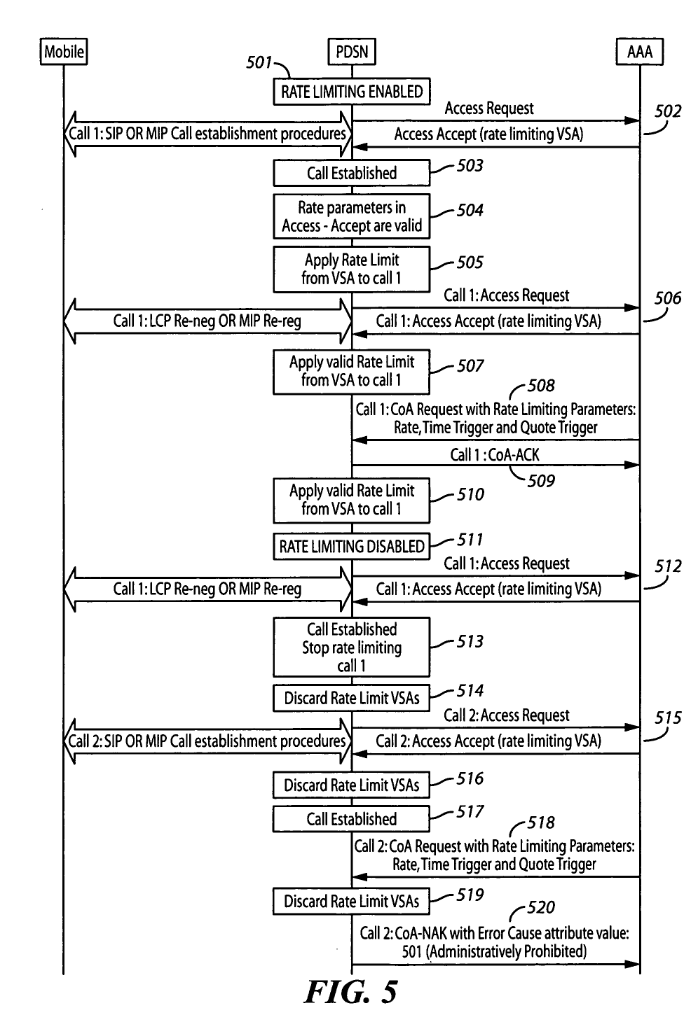

Referring now to FIG. 5 an illustrative transaction example will be provided. This example begins with enablement 501 of rate limitation as described herein at a packet data serving node (PDSN). This PDSN then serves as an intermediary to facilitate call establishment procedures 502 as between a mobile station and an AAA (which may comprise, for example, requests sourced by the mobile station using session initiation protocol, mobile Internet Protocol, or the like). In this example the AAA provides rate limiting information as described herein to the PDSN as a part of these call establishment procedures.

Following establishment of the call 503 the PDSN validates 504 the rate limitation parameters as were received from the AAA and begins to apply 505 this predetermined individual level of usage information with respect to the mobile stations first call. Accordingly, if and as the mobile station's communication resource usage exceeds the limits proscribed by the rate limit information from the AAA the PDSN will take corresponding actions to limit that usage while nevertheless continuing to facilitate the persistence of this first call.

In this example, and during the course of this first call, the mobile station and AAA conduct, via the PDSN, a renegotiation 506 of one or more particulars as relate to the first call. As the first call continues, the PDSN continues to apply 507 the communication resource usage limits as pertain to this individual mobile station. The AAA then transmits, pertinent to the first call, a Change of Authorization request 508 along with corresponding rate limiting parameters (again relating, for example, to data rates and corresponding time or quota triggers). The PDSN provides a corresponding acknowledgement 509 to the AAA and proceeds to employ 510 these rate limitation parameters against a continuing portion of the first call.

In this example, rate limiting for the PDSN now becomes disabled 511 via, for example, the instructions of a system administrator. The PDSN continues, however, to employ communication resource usage control as described above until an event occurs such as completion of the first call or, as illustrated here, the mobile station again conducts a call re-negotiation 512 with the AAA via the PDSN as pertains to the first call. In this case, although the AAA again provides rate limiting parameters to the PDSN the PDSN now facilitates the continuation of the first call without also imposing the communication resource usage limiting 513 described herein. As rate limiting has been disabled, in this example the PDSN then also discards 514 the aforementioned rate limitation parameters as were received from the AAA.

To continue with this example, while rate limiting remains disabled the mobile station effects call establishment procedures 515 for a second call. In this case, and notwithstanding that the AAA will provide rate limiting parameters as correspond to this individual mobile station, the PDSN discards 516 the rate limiting parameters and supports call establishment 517 in the absence of communication resource usage limiting. Much the same occurs when a Change of Authorization request 518 transaction occurs. Again, notwithstanding that the AAA provides corresponding communication resource usage limitation information to the PDSN the latter, in this illustrative embodiment, simply discards 519 that information and responds with a NAK message carrying a 501 attribute value to signal that rate limitation comprises an administratively prohibited function.

So configured, considerable control can be provided with respect to individual rates of communication resource usage. Such usage can be throttled in a manner well calculated to persist provision of previously established services while nevertheless tending to assure that certain end users do not usurp more than an administratively determined fair share of available network communication resources. These teachings require no active participation on the part of the end user platforms and hence can be readily deployed in already-existing communication networks in a compatible manner.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As one illustrative example, these teachings are readily applicable to user groups such as, for example, a group comprising a family of end users (as typified, for example, by so-called cellular service family plans). In such an application setting, a number of end users who comprise a single billing entity might share such limits amongst themselves. In such a case, no limits or more generous limits may be imposed with respect to calls conducted within the group itself, while external calls remain subject to the controls set forth herein.

We claim:

1. A method comprising:
at a network element:
monitoring communication resource usage by at least a first end user;
determining whether the first end user's communication resource usage exceeds a predetermined individual level of usage for that first end user;
when the first end user's communication resource usage exceeds the predetermined individual level of usage, automatically limiting the first end user's communication resource usage while continuing to facilitate the end user's communication resource usage.

2. The method of claim 1 wherein monitoring communication resource usage by at least a first end user comprises monitoring a quantity of transported data.

3. The method of claim 2 wherein the quantity of transported data comprises at least one of:
data transmitted by the first end user;
data transmitted to the first end user.

4. The method of claim 3 wherein the quantity of transported data comprises both data transmitted by the first end user and data transmitted to the first end user.

5. The method of claim 2 wherein the quantity of transported data comprises a quantity of data as has been transported with respect to a predetermined amount of time.

6. The method of claim 1 wherein determining whether the first end user's communication resource usage exceeds a predetermined individual level of usage for that first end user comprises determining whether the first end user's communication resource usage exceeds a predetermined individual level of usage for that first end user after a predetermined period of time following a predetermined event.

7. The method of claim 6 wherein the predetermined event comprises establishment of a call with the first end user.

8. The method of claim 1 wherein automatically limiting the first end user's communication resource usage while continuing to facilitate the end user's communication resource usage comprises automatically limiting the first end user's communication resource usage by dropping at least one data packet.

9. The method of claim 1 further comprising:
receiving from a remote network element the predetermined individual level of usage.

10. The method of claim 9 wherein receiving from a remote network element the predetermined individual level of usage comprises receiving the predetermined individual level of usage from an Authentication, Authorization, and Accounting (AAA) network element.

11. The method of claim 9 further comprising:
detecting a need by the first end user for the communication resource;
obtaining the predetermined individual level of usage for the first end user in response to detecting the need;
facilitating provision of the communication resource to the first end user.

12. The method of claim 1 wherein automatically limiting the first end user's communication resource usage while continuing to facilitate the end user's communication resource usage comprises automatically limiting the first end user's communication resource usage while continuing to facilitate the end user's communication resource usage only when a usage limitation capability for the network element has been enabled.

13. The method of claim 1 wherein automatically limiting the first end user's communication resource usage while continuing to facilitate the end user's communication resource usage comprises automatically limiting the first end user's communication resource usage using a token bucket-based process.

14. The method of claim 1 further comprising:
applying at least one resource usage limiting filter when not automatically limiting the first end user's communication resource usage because the first end user's communication resource usage does not exceed the predetermined individual level of usage.

15. The method of claim 14 wherein the resource usage limiting filter comprises at least one accessible network address limitation.

16. The method of claim 1 wherein when the first end user's communication resource usage exceeds the predetermined individual level of usage, automatically limiting the first end user's communication resource usage while continuing to facilitate the end user's communication resource usage further comprises, when the first end user's communication resource usage exceeds the predetermined individual level of usage:
automatically limiting the first end user's communication resource usage while continuing to facilitate the end user's communication resource usage when the communication resource usage comprises accessing a first information resource;
automatically not limiting the first end user's communication resource usage while continuing to facilitate the end user's communication resource usage when the communication resource usage comprises accessing a second information resource that is different from the first communication resource.

17. A network element comprising:
a memory having stored therein a predetermined individual level of usage for a first end user;
a communication resource first end user usage monitor;
a comparator operably coupled to the communication resource first end user usage monitor and the memory and having a comparison result output that corresponds to a comparison between communication resource usage by the first end user and the predetermined individual level of usage;
a communication resource usage limiter that is operably coupled to the comparison result output and that is configured and arranged to automatically limit the first end user's communication resource usage while continuing to facilitate the end user's communication resource usage when the first end user's communication resource usage exceeds the predetermined individual level of usage.

18. The network element of claim 17 wherein the network element comprises a packet data serving node (PDSN).

19. The network element of claim 17 wherein the communication resource first end user usage monitor comprises a quantity of transported data monitor.

20. The network element of claim 19 wherein the quantity of transported data monitor is configured and arranged to monitor both data transmitted by the first end user and data transmitted to the first end user.

21. The network element of claim 17 wherein the memory further has stored therein a predetermined duration of time and wherein the communication resource usage limiter is further configured and arranged to determine whether the first end user's communication resource usage exceeds the predetermined individual level of usage after the predetermined period of time expires following a predetermined event.

22. The network element of claim 21 wherein the predetermined event comprises establishment of a call with the first end user.

23. The network element of claim 17 wherein the communication resource usage limiter comprises a data packet dropper.

24. The network element of claim 23 wherein the data packet dropper comprises a token bucket-based data packet dropper.

25. The network element of claim 17 further comprising:
a receiver operably coupled to the memory and to a remote network element that provides the predetermined individual level of usage.

26. The network element of claim 17 wherein the communication resource usage limiter is further configured and arranged to:
automatically limit the first end user's communication resource usage while continuing to facilitate the end user's communication resource usage when the communication resource usage comprises accessing a first information resource;
automatically not limit the first end user's communication resource usage while continuing to facilitate the end user's communication resource usage when the communication resource usage comprises accessing a second information resource that is different from the first communication resource; when the first end user's communication resource usage exceeds the predetermined individual level of usage.

27. The network element of claim 17 wherein the communication resource usage limiter further comprises means for automatically limiting the first end user's communication resource usage while continuing to facilitate the end user's communication resource usage when the first end user's communication resource usage exceeds the predetermined individual level of usage.

28. A method comprising:
at a network element:
storing information regarding a plurality of communication network end users, wherein the information comprises, at least in part, predetermined individual levels of usage information;
receiving a message from another network element indicating a need to facilitate providing a given communication network end user with a communication resource;
providing the information as corresponds to the given communication network end user to the another network element such that the another network element can use the information to limit communication resource usage by the given communication network end user.

29. The method of claim 28 wherein the network element comprises an Authentication, Authorization, and Accounting (AAA) network element.

30. The method of claim 28 wherein the predetermined individual levels of usage information comprises a data quantity limit and at least one of:
a data quantity trigger;
a time-based trigger.

31. The method of claim 30 wherein the data quantity limit comprises an individual limit for each of a forward data transport direction and a reverse data transport direction.

32. The method of claim 30 wherein the data quantity trigger comprises a quantity of data sufficient to cause triggering of use of the data quantity limit.

33. The method of claim 30 wherein the time-based trigger comprises a quantity of time to be allowed to pass before triggering use of the data quantity limit.
